(19) United States
(12) Patent Application Publication
(10) Pub. No.: US 2008/0226923 A1
(43) Pub. Date: Sep. 18, 2008

(54) Weldable Corrosion-Protective Agent and Binder Therefor

(75) Inventors: Thomas Kruse, Dortmund (DE); Heike Mertens, Hagen (DE); Gerhard Reusmann, Essen (DE)

Correspondence Address: BACHMAN & LAPOINTE, P.C., 900 CHAPEL STREET, SUITE 1201, NEW HAVEN, CT, 06510, US

(73) Assignee: EWALD DORKEN AG, Herdecke (DE)

(21) Appl. No.: 12/066,266

(22) PCT Filed: Sep. 8, 2006
(86) PCT No.: PCT/EP2006/008775

§ 371 Date: Apr. 23, 2008

(30) Foreign Application Priority Data
Sep. 8, 2005 (DE) 10 2005 042 899.1

(51) Int. Cl. C09D 4/00; C09D 127/12; C09D 185/00; C09D 5/08

(52) U.S. Cl. 428/421; 524/434; 524/413

(57) ABSTRACT

The invention relates to a binding agent comprising at least one titanium and/or one zircon compound (at least 0.5 wt. % in relation to 100 wt. % binding agent), at least one organo-functional silan, in particular, a monosilan, and a solution. The invention is characterised in that the binding agent comprises at least one fluorinated polymer which is insoluble in the binding agent solution. The invention also relates to a corrosion protection agent which is produced using the binding agent and a weldable corrosion protection agent, in addition to a workpiece which is coated with the inventive corrosion protection agent.

The present invention relates to a corrosion-protective agent for metal surfaces which is preferably weldable, and to a binder therefor and a coated workpiece.

There are stringent requirements on corrosion-protective agents which are weldable. They should be easily coated on the metal surface of the workpieces, they should afford reliable corrosion protection, and they should not cause a weakening of the weld seam when the workpieces are welded together.

Weldable corrosion-protective agents containing zinc particles and organic or inorganic binders are well known. These corrosion-protective agents are either based on water or on organic solvents. Aqueous corrosion-protective agents are clearly preferred due to their safe processing.

Typical examples of weldable corrosion-protective agents are described in patent applications DE 197 48 764, DE 199 51 133 and DE 100 22 075 (Henkel). An organic binder in an aqueous solution always has a powdery metal and a so-called corrosion protection pigment added to it. If required, mixtures of solvents are used instead of water. Epoxy resins, as well as blocked PU resins, are amongst the organic binders. If required, hardening agents for the binders are added to the corrosion-protective agent. With these formulae it has been found to be disadvantageous for the corrosion-protective agents to have an insulating effect on the coated workpiece so that welding is made more difficult. For welding it has turned out that ensuring conductivity with organic binders to achieve a quick, complete and flawless welded connection is problematic.

Other binders which are largely inorganic, such as on the basis of titanates and silanes, have slightly improved conductivity. However, the binder still has an insulating effect between the corrosion-protective particles. JP2004-04358A describes a coating agent for forming an antireflection film. It contains a fluorine-containing copolymer dissolved in a solvent. The coating agent described there is not suitable for corrosion protection, in particular not suitable for a weldable corrosion-protective agent.

WO 02/100151 (Adsil) describes a coating wherein the condensation of a silane, amongst others, is catalyzed by small amounts of a metal alcohol. The coating agent can contain PTFE as a hard lubricant, if contact-repellent surfaces are to be created.

It is therefore the object of the present invention to provide a suitable binder for a corrosion-protective agent, in particular a weldable corrosion-protective agent, and a corrosion-protective agent, in particular a weldable corrosion-protective agent which ensures a reliable and secure weld connection while remaining simple to process.

This object has been solved by a binder according to claim 1 and a corrosion-protective agent according to claims 23 and 24, and by a workpiece according to claim 30.

A binder according to the present invention has the following components: at least one titanium and/or one zirconium compound, at least one organofunctional silane and a solvent and at least one fluorinated polymer, which is insoluble in the solvent of the binder, and wherein the titanium and/or one zirconium compound is used in an amount of at least 0.5% by weight with reference to 100% by weight of the binder. The fluorinated polymer added as a solid is of importance, in particular, for good weldability of metallic workpieces which are coated with this binder or with corrosion-protective agents made therefrom, in particular weldable corrosion-protective agents. Even two workpieces coated on both sides can be easily welded if weldable corrosion-protective agents are manufactured using the binder according to the present invention.

The use of titanates and/or zirconates has been found useful according to the present invention, since titanates and zirconates, apart from the well known excellent properties of adhesion promotion, apparently increase the conductivity of the binder or the corrosion-protective agent when the welding temperature is reached. This can be due to the fact that some titanium and/or zirconium compounds—only titanium oxides need be mentioned—exhibit semiconductor properties in the anastatic state.

To enhance conductivity, preferably titanates and/or zirconates, particularly preferably organic titanates or zirconates are used. Chelates, in particular, are suitable for use in binders. Mixtures of different organic titanates and/or zirconates can also be suitably used.

The titanium and/or zirconium compounds are used in an amount of 0.5 weight % to 95 weight % with respect to the binder. For the preferred embodiments of the binder, at least 3 weight %, in particular at least 5 weight %, preferably at least 10 weight %, particularly preferably at least 12 weight %, advantageously at least 15 weight % of the metal compound are used. It has been found advantageous to use up to 80 weight %, particularly preferably up to 70 weight %, preferably up to 50 weight %, advantageously up to 40 weight %, each with respect to the binder.

Organofunctional silanes or mono silanes are known as components of binders. According to a further development, preferably methylphenyl-, phenyl- and methyl silicone resins are used in the binder according to the present invention. Silicone resins with vinyl or allyl groups, acryl esters, ethyleneimino groups, fluorinated phenyl residues, fluorine derivates, hydroxyorgano groups, carboxyorgano groups, aminoalcyl groups, siloxane-silazane mixed polymerisates, silane compounds with phenylene groups or with co-condensation products with organic resins can also be considered. Mixtures of the above-mentioned silane compounds are also possible.

The at least one organofunctional silane or the at least one organofunctional monosilane is preferably chosen such that its decomposition temperature is below the welding temperature. The organofunctional silane is therefore largely decomposed before or at the latest at the point where the welding temperature is reached. The substantial or complete decomposition of the silane contributes to the formation of a uniform welding seam. The organofunctional silane is used preferably in an amount of 0.01 weight % to 20 weight % with respect to the binder. The use of more than 2 weight %, preferably of more than 5 weight % is advantageous. According to a suitable embodiment of the present invention, formulae contain up to 15 weight %, particularly advantageously up to 12 weight %, up to 10 weight % of the organofunctional silane are preferably used, particularly preferably up to 7 weight %, each with respect to the binder. Each amount of the organofunctional silane or the mixture of organofunctional silanes to be used depends on each intended application and the requirements on the processing of the binder.

According to an advantageous embodiment, the binder has an organic solvent or a mixture of organic solvents. Alcohols, aliphatic and/or aromatic hydrocarbons and esters are particularly suitable.

Surprisingly it has been found that solid fluorinated polymers insoluble in the solvent of the binder have a binding behavior unlike that of the usual binders or polymers. Such insoluble fluorinated polymers do not uniformly spread on all surfaces, in particular not on metallic surfaces. They therefore have a tendency to set in the form of insulas or dots. This mostly undesirable behavior ensures, however, in the present case that a binder with a fluorinated polymer, when used, in particular, as a corrosion-protective agent, provides improved contact of conductive particles, in particular of corrosion-protective particles, among each other, since the powderous polymer—unlike a liquid binder—does not spread on the metal surface to be coated or on the conductive particles. The contact between the conductive particles and the metal surface therefore remains excellent without the hitherto usual infiltration by the binder, so that a highly effective corrosion protection coating is formed. When used as a weldable corrosion-protective agent, the direct binding of the corrosion-protective particles ensures excellent conductivity.

The fluorinated polymere is preferably used in powder form in the binder. It is therefore insoluble in the solvent of the binder. The powderous polymer melts at higher temperatures and hardens at a temperature above room temperature and below welding temperature. It thus forms point-shaped connections so to speak, so that the adhesion of the metal particles, essential for corrosion protection, is optimally maintained. It has been found to be particularly advantageous that the fluorinated polymer does not lose its binding capability even after repeated heating. While it may not be avoidable that parts of the fluorinated polymer are decomposed each time it is heated, the remaining portions still contribute to binding within the coating each time it is re-heated. The preferable particle diameter of the powdery fluorinated polymer depends on the desired film thickness of the coating made from the binder. It is preferably up to 20 μm, particularly preferably up to 10 μm, advantageously up to 5 μm.

At least one fluorinated polymer is necessary in the binder to achieve the effect according to the present invention. Mixtures of fluorinated polymers may also be used. The following fluorinated polymers are particularly preferred, singly or in mixture: polytetrafluoroethylene (PTFE), polyvinylidene fluoride (PVDF), tetrafluoroethylene/hexafluoropropylene-copolymer (FEP), perfluoroalcoxy-copolymer (PFA), copolymer of tetrafluoroethylene with perfluorinated propylene and perfluoroalcylvinylether (EPE), copolymer of tetrafluoroethylene and perfluoromethylvinylether (MFA), copolymer of tetrafluoroethylene with ethylene (ETFE), polychlorotrifluoroethylene (PCTFE) and copolymer of ethylene, and chlorotrifluoroethylene (ECTFE).

A preferred embodiment of the binder according to the present invention provides that a fluorinated polymer is used with a melting point between 100° C. and 500° C., preferably between 150° C. and 350° C. The choice of such a fluorinated polymer ensures that the fluorinated polymer has largely, or even completely, decomposed when the welding temperature is reached.

Since, according to a further preferred embodiment, the organofunctional silane has also substantially decomposed when the welding temperature is reached, the metal particles necessary for corrosion protection are in contact with each other largely unhindered by the binder when using the binder for weldable corrosion-protective agents so that an optimum corrosion protection is ensured.

Depending on the use of the binder according to the present invention, the use of the fluorinated polymer can vary widely, from 0.1 weight % to 20 weight %, where 15 weight % are preferred, particularly preferred up to 10 weight %, advantageously more than 5 weight %, particularly advantageously at least 2.5 weight %, each with respect to the binder.

The fluorinated organic polymer is used with an average particle diameter of at least 7.5 HE, preferably of 5 HE, particularly preferably of 6 HE to a maximum of 3 HE. Indication and measurement of the particle size is according to ASTM D 1210.

The binder according to the present invention as defined in claim 1 or according to any one of the above described embodiments, can be selectively further developed for special applications when co-binders are added. Co-binders can elastify the binder, for example, if necessary. However, they can also improve adhesion of the binder or of the corrosion-protective agent made using the binder on the workpiece.

Suitable co-binders are in particular, liquid organic binders. Co-binders are used preferably in an amount of 0.01 weight % up to 20 weight %. Acrylate resins, aldehyde resins, alcyd resins, epoxy resins, epoxy resin esters, cetone resins, maleate resins, melamine resins and phenol resins can be used, for example, singly or in a mixture.

According to an advantageous further embodiment, the binder has additives, in particular additives for adjusting viscosity, rheology, wetting and dispersing characteristics, deposition behavior, the adjustment of storage stability, sliding properties and processing characteristics. By adding the per se well known additives, the binder is adjusted to the requirements given by the application purpose or the processing properties. The viscosity and the rheological behavior of the binder are not only of importance, for example, when mixing with corrosion-protective particles or pigments, but also when the binder or a coating manufactured with the use of the binder is applied to the surface of workpieces. Wetting and dispersion properties and deposition behavior are usually adjusted to simplify the introduction and uniform suspension of particles, whether they are fluorinated polymers in the form of particles, or metal particles, salts or pigments. Additives for adjusting the sliding properties are aimed at adjusting the characteristics of the coatings obtained with the binder or used in coating agents manufactured with the binder. Additives, which adjust the storage characteristics, aim at preventing early reaction of the binding agent or the coating agents manufactured therewith.

The use of the additives is preferably between 0.01 weight % and 20 weight %. The proper amount to be used is determined by means of simple optimizing tests.

The binder according to the present invention advantageously has a baking temperature between 150° C. and 350° C., preferably of 150° C. to 200° C. The indication of the baking temperature refers to each object temperature required for baking the coated workpiece. The wide spectrum of the adjustable baking temperatures is advantageous, in particular, when workpieces of high-strength steels are to be coated. Such materials should not be heated to elevated temperatures so as not to negatively affect the material strength. According to the present invention it is easily possible to adapt the binder and also the corrosion-protective agents made thereof to these requirements.

The baking duration is preferably between 1 second and 90 minutes. It essentially depends on the baking temperature to be reached and on the way in which the baking temperature is generated. Inductive methods usually work with very short baking times, methods using convective heat transfer usually need longer baking times. A baking duration of between 30 seconds and 30 minutes is preferred, particularly preferred of between 1 minute and 20 minutes. The binder according to the present invention does not have to rely on the use of particular methods or installations for baking.

The above described binder is suitable for use in corrosion-protective agents. For this purpose the binder has added to it corrosion-protective particles, in particular metal particles, preferably zinc or aluminum particles, or metal salts, or a mixture of different metal particles, or metal salts or a mixture of metal particles and metal salts.

The advantageous effects of the titanium or zirconium compounds and the fluorinated polymer and the organofunctional silane preferably chosen as a function of the required product properties, when the binder is used in a corrosion-protective agent, have been explained in detail above. The components according to the present invention of the corrosion-protective agent are primarily the above-mentioned corrosion-protective particles, as well as the binder.

The corrosion-protective agent according to the present invention preferably comprises at least 0.1 weight % up to 95 weight %, preferably up to 85 weight %, particularly preferably up to 70 weight %, advantageously up to 60 weight %, particularly advantageously up to 35 weight % corrosion-protective particles, each with respect to the corrosion-protective agent.

The corrosion-protective agent according to the present invention, according to an advantageous embodiment, is adjusted such that the dry film thickness of the finished coating is 1 μm to 50 μm, preferably up to 20 μm, particularly preferably up to 15 μm, advantageously up to 5 μm. The dry film thickness can be determined, mainly by the selection of metal and/or salt particles of a suitable size. The dry film thickness can also be adjusted by the respective aggregates with which the corrosion-protective agent is applied.

It must be seen as a particular advantage of the corrosion-protective agent according to the present invention that it has excellent electric conductivity over and above the state of the art.

If a weldable corrosion-protective agent is used according to the present invention, it is characterized, in particular, in that two workpieces, both coated on both sides, can be welded to each other. When two workpieces both coated on both sides are welded together, a total of four layers of weldable corrosion-protective agent must be overcome to achieve a strong weld connection. A technically realizable coating which reliably solves this problem is hitherto unknown. It has only been possible by using the weldable corrosion-protective agent according to the present invention. This is also due to the hardly diminished conductivity—unlike the prior art—between the welding electrodes that occurs when workpieces are welded together which are coated with the weldable corrosion-protective agent according to the present invention.

A particular advantage of the weldable corrosion-protective agent according to the present invention must be seen in that reliable welds are created even in dot welding with processing times of about 80 ms, wherein neither evaporated metal nor binder residues, in particular of the monosilane, cause weak points in the weld.

The binder according to the present invention and the coating agents made thereof, in particular corrosion-protective agents and/or weldable corrosion-protective agents, may be easily processed. They can be applied to the surface of workpieces using any known application method, such as doctored, sprayed, painted, dipped, rolled and the like.

Details of the invention will be explained in more detail in the following with reference to exemplary embodiments:

### Binder I

Binder 1 is comprised of the components mentioned in claim 1 essential for the effect of the binder according to the present invention:

trimethoxyvinylsilane: 11 weight %,

titanium-ethylhexanolate (tetra-2-ethylhexyl titanate): 27 weight %,

n-butyl polytitanate (titanium tetrabutanolate, polymer): 41 weight %,

polyvinylidene fluoride: 4 weight %, and

alcohol: 17 weight %,

sum: 100 weight % with respect to the binder—all indications with respect to binder I and II each relate to the binder.

Manufacture of the binder I is explained in the following.

Binder II with Additives (Prepared for Improved Mixing with Corrosion-Protective Agent)

Trimethoxyvinylsilane: 9.5 weight %,

titanium-ethylhexanolate (tetra-2-ethylhexyl titanate): 24 weight %,

n-butyl polytitanate (titanium tetrabutanolate, polymer): 35.5 weight %,

alcohol: 14 weight %,

polyvinylidene fluoride: 3.5 weight %, and

antisettling agent: 11 weight % overall. Various antisettling agents are used, here: 2.5 weight % amorphous silicic acid, 3 weight % paint additives Y 25 SN (Ashland) and 5.5 weight % Ethocell 45 solution 11% in alcohol of Ewald Dbrken AG and wetting and dispersing additive: 2.5 weight % Disperbyk 160 solution 20% in aromatic hydrocarbons (Ewald Dbrken AG)

sum: 100 weight % with respect to the binder.

### Manufacture of Binder I and II

These binder formulae I and II are each prepared in a coolable and heatable process container with integrated, infinitely variable stirring apparatus. The above mentioned components for binder I and binder II are consecutively mixed in the process container while stirring in the above mentioned sequence. The temperature is between −10° C. and +60° C. The stirring apparatus is set to 1000 rpm and the binder is mixed for 5 minutes after adding each component.

The binder has a baking temperature of 200° C.

A composition of corrosion-protective agents according to the present invention will be described in the following in an exemplary manner. The formula for a weldable corrosion-protective agent is also given:

### Corrosion-Protective Agent I

43 weight % of binder II had added to it 55 weight % zinc paste (zinc paste: 90 weight % zinc dust, stabilized with 10 weight % organic solvent) with an average diameter of the zinc particles of about 4 μm, and with 2 weight % aluminum paste. Zinc and aluminum particles are for cathodic corrosion protection. This formula of the corrosion-protective agent I is 100 weight %.

### Corrosion-Protective Agent II

The corrosion-protective agent II described here is a weldable corrosion-protective agent. 45 weight % of binder II had added to it 25 weight % zinc paste (zinc paste: 90 weight % zinc flake, stabilized with 10 weight % organic solvent) having an average diameter of the zinc particles of about 4 μm, and 25 weight % iron phosphide. The zinc particles and the iron phosphide were used as corrosion-protective particles. Then 5 weight % of an organic solvent are added to adjust viscosity. If no solvent is necessary, more binder, zinc paste and iron phosphide is added in a ratio of 2:1:1 to corrosion-protective agent II. The prescribed composition of the weldable corrosion-protective agent is 100 weight %.

To produce the weldable corrosion-protective agent, the binder is provided. Mixing in the corrosion-protective particles is carried out in the prescribed process container at 1850 rpm for 15 minutes. The production of the weldable corrosion-protective agent is carried out in a temperature range from room temperature to not more than 40° C.

The weldable corrosion-protective agent is applied to the components of the B-pillar in an automotive vehicle body. The baking temperature, measured as the object temperature, is 200° C.; the baking duration in a continuous convection furnace is 30 minutes. The dry film thickness of the corrosion protection coating is 10±3 μm. This coating withstands the salt spraying test according to DIN 50 021 for at least 48 hours without red rust formation.

Two components of the B-pillar having a material thickness of 2 mm and both coated in the above described manner with the corrosion-protective agent II are dot welded by means of electrodes. The thus dot welded components can be used for the construction of motor vehicles.

1. A binder, comprising:
at least 1 titanium and/or zirconium compound in an amount of at least 0.5 weight % with respect to 100 weight % of the binder.
at least one organofunctional silane, in particular a monosilane and
a solvent,
characterized in that
the binder comprises at least one fluorinated polymer, in which the solvent of the binder is insoluble.

2. The binder according to claim 1, characterized in that the at least one titanium and/or zirconium compound is a titanate and/or a zirconate, preferably an organic titanate and/or zirconate.

3. The binder according to claim 2, characterized in that a titanium and/or zirconium chelate is used as the organic titanium and/or zirconium compound.

4. The binder according to claim 1, characterized in that the at least one titanium and/or zirconium compound is present in an amount of 0.5 to 95 weight %, preferably at least 3 weight %, 5 weight %, 7 weight %, preferably at least 10 weight %, particularly preferably at least 12 weight %, advantageously at least 15 weight %.

5. The binder according to claim 1. characterized in that the at least one titanium and/or zirconium compound is added in an amount of 0.5 to 95 weight %, preferably up to 80 weight %, particularly preferably up to 70 weight %, advantageously up to 50 weight %, particularly advantageously up to 30 weight %, each with respect to the binder.

6. The binder according to claim 1, characterized in that, as the organofunctional silane a silane compound is chosen from the group comprising methylphenyl, phenyl and methyl silicone resins, the silicone resins with vinyl or allyl groups, acryl esters, ethyleneimino groups, fluorinated phenyl residues, fluorine derivates, hydroxyorgano groups, carboxyorgano groups, aminoalcyl groups, of the siloxane-silane-mixed polymerisates, of the silane compounds with phenylene groups or the silane compounds with co-condensation products with organic resins, or a mixture of the mentioned silane compounds.

7. The binder according to claim 1, characterized in that at least one organofunctional silane is used in an amount of 0.01 to 20 weight %, advantageously of more than 2 weight %, preferably more than 5 weight %, preferably up to 15 weight %, particularly preferably up to 12 weight %, advantageously up to 10 weight %, particularly advantageously up to 7 weight %, each with respect to the binder.

8. The binder according to claim 1, characterized in that the decomposition temperature of the organofunctional silane is below the welding temperature.

9. The binder according to claim 1, characterized in that the solvent is an organic solvent, in particular a solvent or a mixture of solvents from the group comprising alcohol, aliphatic and aromatic hydrocarbons and esters.

10. The binder according to claim 1, characterized in that the binder is a fluorinated polymer or a mixture of fluorinated polymers.

11. The binder according to claim 1, characterized in that the binder is one of the fluorinated polymers or a mixture of the fluorinated polymers selected from the group comprising polytetrafluoroethylene (PTFE), polyvinylidene fluoride (PVDF), tetrafluoroethylene/hexafluoropropylene copolymer (FEP), perfluoroalcoxycopolymer (PFA), copolymer of tetrafluoroethylene with perfluorinated propylene and perfluoroalcylvinylether (EPE), copolymer of tetrafluoroethylene and perfluoromethylvinylether (MFA), copolymer of tetrafluoroethylene with ethylene (ETFE), polychlorotrifluoroethylene (PCTFE) and copolymer of ethylene and chlorotrifluoroethylene (ECTFE).

12. The binder according to claim 1, characterized in that the at least one fluorinated polymer has a melting point between 100° C. and 450° C., preferably a melting point between 150° C. and 350° C.

13. The binder according to claim 1, characterized in that the fluorinated polymer is used in a proportion of 0.1 % by weight to 20% by weight, advantageously up to 15 weight %, particularly advantageously up to 10 weight %, preferably more than 5 weight %, particularly preferably more than 2.5 weight %, each with respect to the binder.

14. The binder according to claim 1, characterized in that the fluorinated polymer insoluble in the solvent of the binder has an average particle diameter in the range of between 7.5 HE and 3 HE, preferably between 6 HE and 3 HE, preferably between 5 HE and 3 HE, measured according to ASTM D 1210.

15. The binder according to claim 1, characterized in that at least one co-binder is used.

16. The binder according to claim 15, characterized in that the at least one co-binder is used in an amount of 0.01 to 20 weight % with respect to the binder.

17. The binder according to claim 15, characterized in that the at least one co-binder is a soluble organic binder.

18. The binder according to claim 15, characterized in that the at least one co-binder or a mixture of such co-binders is selected from the group comprising acrylate resins, aldehyde resins, alcyd resins, epoxy resins, epoxy resin esters, cetone resins, maleate resins, melamine resins and phenol resins.

19. The binder according to claim 15, characterized in that the binder comprises additives, in particular additives for adjusting viscosity, rheology, wetting and dispersing characteristics, deposition behavior, for adjusting storage stability, slipping characteristics and processing characteristics.

20. The binder according to claim 19, characterized in that an additive or a mixture of additives is used in the binder in an amount of 0.01 weight % to 20 weight % with respect to the binder.

21. The binder according to claim 15, characterized in that the object temperature during baking is 100° C. to 500° C., preferably between 150° C. and 350° C.

22. The binder according to claim 15, characterized in that the baking duration is between 1 second and 90 minutes, preferably between 30 seconds and 30 minutes, particularly preferably between 1 minute and 20 minutes.

23. A corrosion-protective agent, comprising a binder according to claim 1 and having corrosion-protective particles.

24. A corrosion-protective agent, comprising a binder according to claim 1 and having corrosion-protective particles, characterized in that it is a weldable corrosion-protective agent.

25. A corrosion-protective agent according to claim 23, characterized in that metal salts, singly or in mixture, in particular iron phosphide or molybdenum disulphide and/or graphite are used as corrosion-protective particles.

26. The corrosion-protective agent according to claim 23, characterized in that metal particles or particles of a metal alloy, in particular zinc and/or aluminum particles, are used as corrosion-protective particles.

27. The corrosion-protective agent according to claim 23, characterized in that corrosion-protective particles are used in an amount of 0.1 weight % to 95 weight %, preferably up to 85 weight %, particularly preferably up to 70 weight %, advantageously up to 60 weight %, particularly advantageously up to 35 weight %, each with respect to the corrosion-protective agent.

28. The corrosion-protective agent according to claim 23, characterized in that the corrosion-protective agent is composed in such a way that its dry film thickness is up to 50 μm, preferably up to 20 μm, particularly preferably up to 15 μm, advantageously up to 5 μm.

29. The corrosion-protective agent according to claim 23, characterized in that it ensures a resistance against the salt spraying test according to DIN 50 021 of at least 48 hours for a workpiece coated therewith and to be welded.

30. A workpiece of metal, coated with a corrosion-protective agent according to claim 23.
